(19) United States
(12) Patent Application Publication
(10) Pub. No.: US 2007/0136328 A1
(43) Pub. Date: Jun. 14, 2007

(54) System and method for managing files to be attached to and detached from an electronic document

(75) Inventor: Fernando Incertis Carro, Valencia (ES)

Correspondence Address: BOND SCHOENECK & KING, PLLC, ONE LINCOLN CENTER, SYRACUSE, NY, 13202, US

(73) Assignee: International Business Machines Corporation, Armonk, NY (US)

(21) Appl. No.: 11/523,684

(22) Filed: Sep. 19, 2006

(30) Foreign Application Priority Data
Nov. 25, 2005 (EP) 05111320.7

(51) Int. Cl. G06F 7/00

(52) U.S. Cl. 707/100

(57) ABSTRACT

A file is attached by a sender to an electronic document. The directory path corresponding to the attached file, is lexicographically encoded and merged with the file name of the attached file to form a file location identifier that contains the location where the file is detached at a recipient's system.

### PRIORITY CLAIM

The present application claims priority to European Patent Application No. 05111320.7, filed Nov. 25, 2005, the contents of which are hereby incorporated by reference.

### TECHNICAL FIELD OF THE INVENTION

The present invention relates generally to the field of managing files embedded within an electronic document and, more particularly, to a system and method for associating specific locations to automatically save and retrieve the files.

### BACKGROUND ART

There are many software applications capable of attaching copies of files to electronic documents. Examples of such software systems include, but are not limited to, electronic mail systems, database systems, as well as collaborative systems such as Lotus Notes™ (Lotus Notes is a registered trademark of Lotus Development Corporation). Anything that can appear as a file somewhere in hard disk folders can be included as an attachment to an electronic document. Attachments can be made of images, word-processing documents, database files, spreadsheets, audio files, executable programs, etc.

Once a file is attached to an electronic document, the document, as well as the attached file, can be transmitted over a communications network (e.g., the Internet) to other computer systems. Multiple users can access the attached file using suitable collaborative software, typically over a computer communications network. Using conventional software, files attached to electronic documents can be operated in several ways. For example, on Lotus Notes™ an attached file can be viewed with a file viewer, launched or processed by another application, or detached from the electronic document and stored to process the file locally or, as in the case of a program file, to be executed.

To detach a file from an electronic document and create a local copy of the attached file, the user typically (as in Lotus Notes™), highlights the file to be detached, selects a detach option, and interacts with a “file save” interface by means of which the user must specify a filename for the local copy of the attached file and the location (i.e., the folder or directory path) to which the file must be detached. This process can be tedious for the user, mainly when multiple files are to be detached. Although some systems enable multiple attachments to be detached simultaneously, each of the attachments must be detached to the same directory despite the type of attached file or the intended use of the attached file. Additionally, conventional systems first query the user as to where the user would like the attached files to be detached.

To illustrate the need for improving current systems and methods for attaching and detaching files to and from electronic documents, one may consider the scenario of creating a repository of files detached from e-mail on a personal computing system. In the course of one year hundreds of files may be typically received by a user, included on attachments of e-mail received from many different senders. Files received by the user can be of all types (i.e., e-mail attachments can be images, pictures, maps, presentation materials, word-processing documents, database files, spreadsheets, MP3 or video files, executable programs, and so); and can be related to quite different categories, subjects, topics or sub-topics (e.g., family pictures, a project documentation, folk music, medieval art, and so). Those files are usually detached by the user, and stored on folders, from where occasionally, they may be accessed by the user, reviewed and attached to new documents, or to outgoing e-mail, being redistributed to many people.

When a user needs to detach a file from an electronic document, if the file is related with a new topic, for which there is not yet a specific folder created beforehand to which save the file, the user is faced with the tasks of, identifying and assigning a new category (and sometimes, one or more sub-categories) to the received file, of naming the new category (and other sub-categories, if defined), and then of creating the corresponding directory (and other required sub-directories) on the file system of the user's computer before saving the attached file in the corresponding folder.

At any time, the user should be able to identify and specify, with a minimum effort, the destination of those detached files (e.g., to better classify, organize and search for received files related with specific subjects and topics). Moreover, when a user receives files attached to electronic documents, it would be of the utmost importance for the user to automate the process of saving said files on folders related with the sources or subjects of said received files, in such a form that files accessed or received at different times from the same sources would be saved on the same folders corresponding to said subjects.

Therefore, there is a need for automating the process for saving files detached from electronic documents to specific locations related with the sources or the subjects of said files.

Several systems and methods have been already proposed providing automatic mechanisms for detaching or removing file attachments, from electronic documents to specific destination locations. Some of those prior art systems and methods identify the locations (i.e., the folders) where the attached files are to be stored based on simple predefined criteria (such as attached file type). For example, U.S. Patent Application Publication No. 20030182331, entitled “Method and system for detaching files to a specified location”, by Demsky et al., discloses a method, responsive to a user command, for automating the process of detaching files attached to electronic documents by identifying the locations where the attached files are to be stored. A file attached to a received electronic document can be automatically detached to a location within a data store such that the recipient does not need to specify the location to which the file is to be detached. The disclosed method includes identifying a “default” location where the attached file is to be stored responsive to a user command and wherein the default location can be associated with the particular file attached to the electronic document (e.g., to the file types of the attached files). The default locations can also be stored within the electronic document to which files are attached, or within the attachments themselves.

The main drawback of the system and method disclosed on Demsky's reference consists in that if the default location to which an attached file is to be detached is encoded on the electronic document, then a problem arises when the electronic document is edited by a user (e.g. the recipient) before the file attachment is detached. Since the detach location specified by the sender is encoded on the same document, separately from the attached files, there is a risk that the encoded detach location could be lost before the attached file is saved.

FIG. 1 illustrates the drawbacks of such conventional systems for detaching files from documents. Basically, when a file (100) is attached to a document (101) (e.g. an e-mail), the information about the subject/item and category of the attached file, specified by the directory path (102) of the file on the sender's computer (103) file system (104), is lost, since the directory path name (102) is not copied on the document (101), neither included as a full name qualifier of the attached file (100).

Another limitation of the prior art solution is that no detail is described on how to associate each file attached to an electronic document with a corresponding “default” location encoded on the same electronic document, to which each file must be saved when detached.

Alternatively, if the default location to which an attached file must be detached is encoded “within the attachment itself”, then this location must necessarily be embedded as metadata on the file itself. And a major limitation of today metadata embedding methods is the lack of standardization on the way to integrate metadata into the many different possible types of files and file formats, particularly on image, video, audio or executable files. Moreover, it is to be appreciated that such algorithms to encode and extract metadata are complex ones. Finally, a last drawback of today metadata embedding methods is the need to open and process the file to extract the metadata before detaching the file.

Therefore, a need has arisen for a system and method for automating the process of attaching and detaching file attachments to/from electronic documents.

### SUMMARY OF THE INVENTION

It is a broad object of the invention to automate the process of attaching and detaching electronic documents attachments.

It is another object of the invention to automate the process for saving files detached from received electronic documents to specific logic locations and directory paths specified by the senders of said files.

It is still another object of the invention to enable users to exchange files while keeping exchanged files consistently organized in similar directory paths.

According to the invention there is provided a system and method for attaching files to an electronic document as described in the appended independent Claims.

Further aspects of the invention are provided by the further embodiments described in the appended dependent Claims.

According to a first embodiment, a method of attaching at least one file, saved on a sender file system, to an electronic document, comprises the steps of:
(a) selecting a filename of the at least one file to be attached;
(b) encoding the corresponding file directory path name where the at least one file is saved on the sender file system;
(c) merging the encoded file directory path name with the selected filename to form a file location identifier thereby indicating a location where to save the file on a receiver file system; and
(d) generating into the electronic document an attached file from the file location identifier.

According to a further aspect of the present invention, a computer program product stored on a medium readable by a computer machine is disclosed. The computer program product tangibly embodies readable program means for causing the computer machine to perform the method of attaching files to an electronic document as described in the appended claims.

According to another embodiment, a method of detaching at least one file from an electronic document on a receiver file system, the at least one file being referenced by a file location identifier, the method comprising the steps of:
(a) extracting from the electronic document the file location identifier of the at least one file to be detached;
(b) parsing the extracted file location identifier to decode the file directory path name and the filename associated to said file location identifier;
(c) generating a saving location associated to the file directory path name; and
(d) saving with the filename the at least one file at the associated saving location.

According to a further aspect of the present invention, a computer program product stored on a medium readable by a computer machine is disclosed. The computer program product tangibly embodies readable program means for causing the computer machine to perform the method of detaching files to an electronic document as described in the appended claims.

Finally, a machine-readable storage is disclosed. The storage has stored thereon, a computer program having a plurality of code sections executable by a machine, wherein a first plurality of said code sections causing the machine to perform the steps of the attaching method when executed on the machine and a second plurality of said code sections causing the machine to perform the steps of the detaching method when executed on the machine.

### BRIEF DESCRIPTION OF THE DRAWINGS

Reference will now be made, by way of example, to the accompanying drawings in which:

FIG. 1 illustrates a prior art system for attaching a file to an electronic document;

FIG. 2 illustrates the method of attaching a file to an electronic document as operated by the present invention;

FIG. 3 illustrates the method of detaching a file from an electronic document as operated by the present invention;

FIG. 4 is a flow chart of the steps of the attaching method of the present invention;

FIG. 5 details the encoding step of the method of FIG. 4.

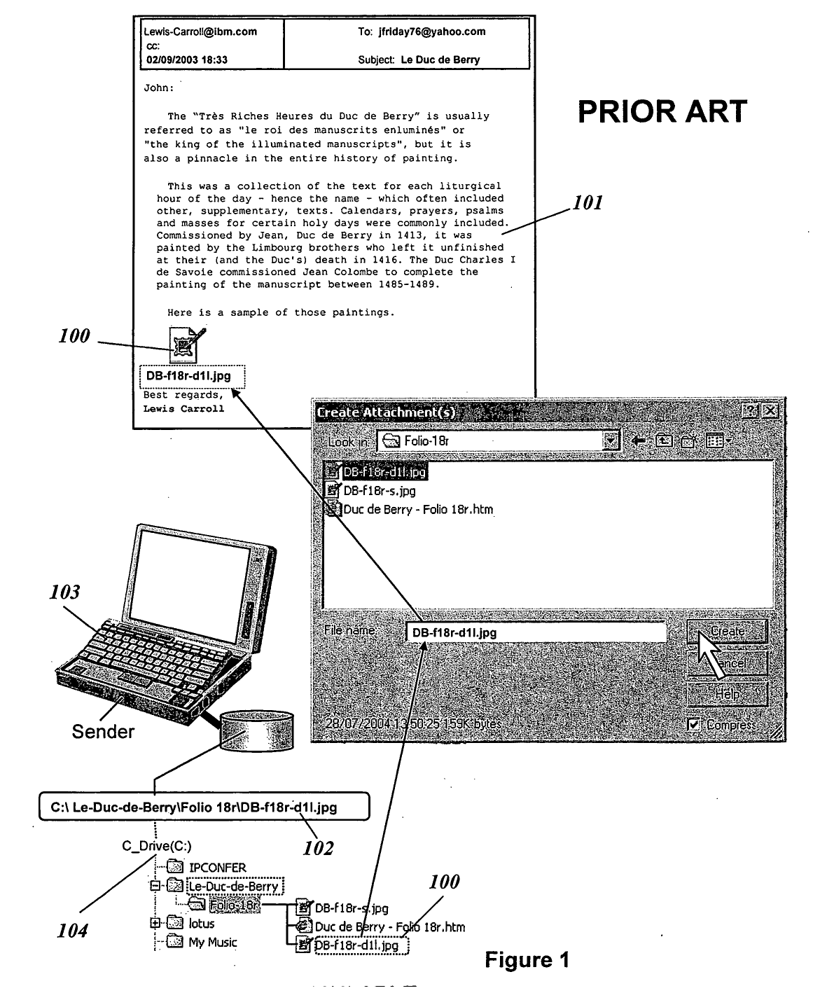

### DETAILED DESCRIPTION OF THE PREFERRED EMBODIMENT

Principle of the Invention

To overcome the drawbacks of the prior art, the present invention provides a universal mechanism for attaching files to electronic documents while specifying on the same attached files the locations to which they must be saved when detached by the recipients of said documents.

According to the invention, a file attached to an electronic document can be detached automatically to a location within a data store in such a way that the recipient is not forced to specify the location to which the file must be stored.

In the method of the present invention the location at which a file attached to a document is to be detached, is not externally encoded on the electronic document. It is neither internally encoded as metadata within the attachments themselves. On the contrary the location is advantageously encoded into the filename of the attached file.

The invention is based on the principle of encoding the full directory path name on the file system from which a file is attached, as a file name qualifier using lexicographic rules. According to the invention, the filename of a file attachment is combined with the full directory path name of the file in the host computer, using a particular lexicography. The lexicography is predetermined so as to avoid particular characters that may be forbidden (i.e. invalid or not allowed) by the file naming conventions on the sender and the receiver file systems for encoding file names. For example, the “\” and “:” symbols in the Microsoft Windows file system are reserved for denoting roots drives or directory paths of file folders, and thus cannot be used for encoding file names. The forbidden characters “\” and “:” are replaced by corresponding valid characters or by sequences of valid characters, here “(” and “..”, respectively.

Method for Attaching Files to Electronic Documents

One aspect of the present invention includes a method, responsive to a user command, for attaching a file to an electronic document. The method associates to the filename of the attached file the location where it is saved when detached. The method further includes encoding the location (i.e., the full directory path name of the folder) where the file is saved when detached from the electronic document by a recipient, using lexicographic encoding rules. The save location encoded on the filename of the attached file may be related to or identical to the corresponding location of the file on the sender's system.

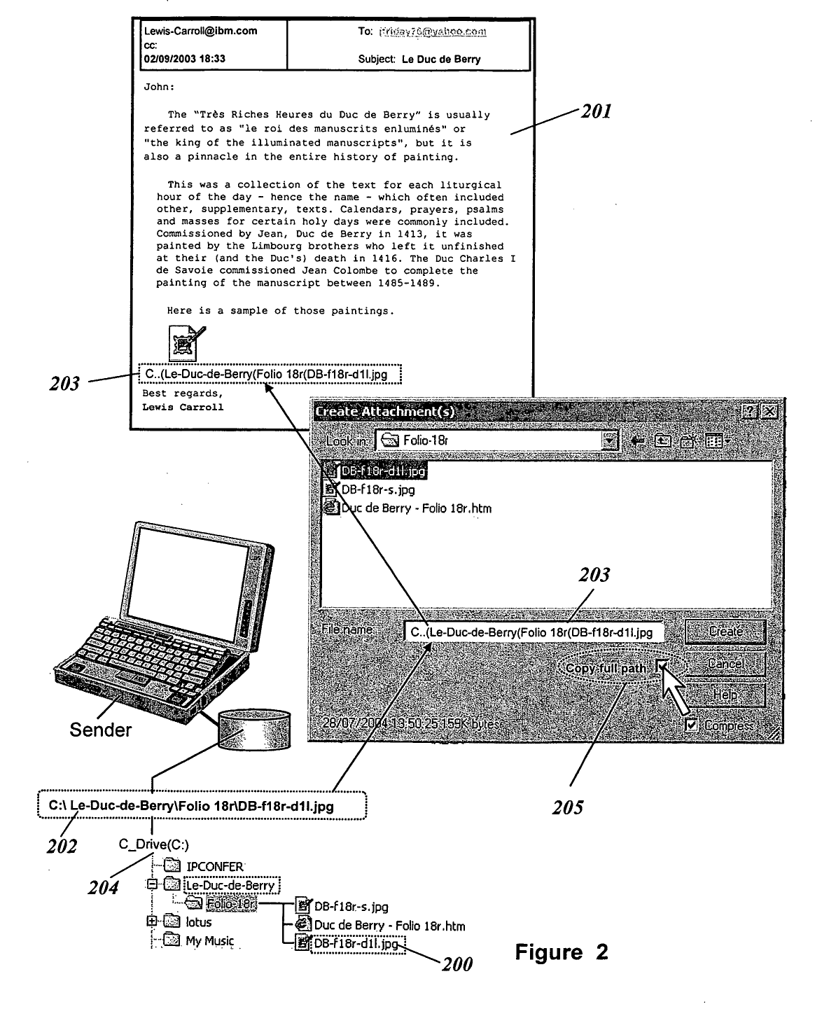

FIG. 2 illustrates the disclosed method for attaching a file (200) to an electronic document (201) (e.g., to an e-mail). The directory path (202) of the attached file is lexicographically encoded to form a directory qualified path name for the attached file. In the example shown in this figure, the file (200) to be attached (here named “DB-f18r-d1l.jpg”) is located on a directory path (here named “C:/Le-Duc-de-Berry/Folio 18r/”) of the sender's file system (204). The directory path is encoded using lexicographic rules and the encoded directory path name is appended to the original file name (200) to get a detaching file name (203) (here “C..(Le-Duc-de-Berry(Folio 18r(DB-f18r-d1l.jpg”) to which the attached file is associated. The skilled man will appreciate that maximum available filename lengths of most modem file systems enable to implement the principle of encoding on the filename of a file a full directory path.

Method for Detaching Files from Electronic Documents

The present invention also provides a method and system for automatically detaching files from electronic documents to locations associated with the attached files. The method, responsive to a user command, includes identifying a location where the attached file is saved, this location being associated with the attached file. The method further includes parsing the filename of the attached file using the same lexicographic rules applied by the sender for encoding filenames of file attachments. The location (i.e., the full path of the folder) where the file is to be saved when it is detached is decoded from the filename of the attached file.

Furthermore, the present method further includes creating on the recipient's computer file system the directory and all sub-directories specified by the full path decoded from the file name of the attached file.

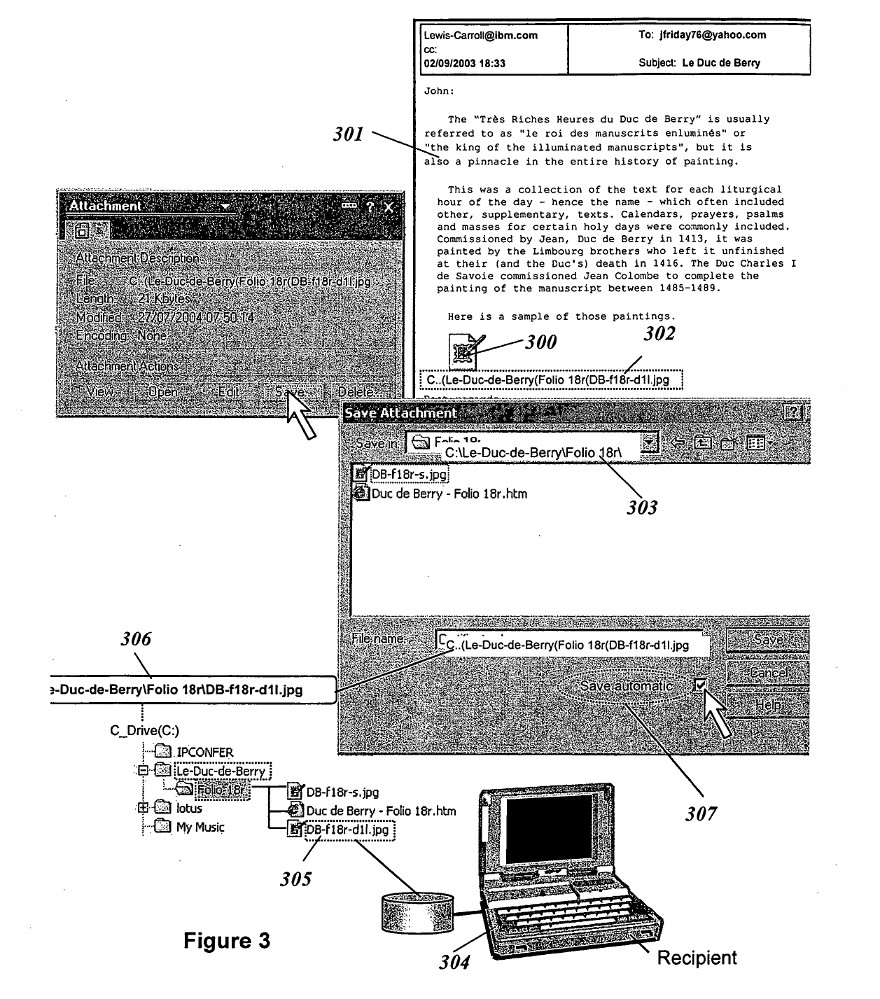

FIG. 3 illustrates the disclosed method for detaching from an electronic document (301) (e.g., from an e-mail) a file attachment (300) having a file name (302) encoded according to the encoding method previously explained. By lexicographically decoding the directory path (303) as encoded on the filename of the received file, the recipient's computer (304) can save the detached file (305) into a location (306) (i.e., into a directory path) that corresponds to the location specified by the sender. As shown on FIG. 3, when detaching from an electronic document a file attachment having a directory path encoded file name (302) (here “C..(Le-Duc-de-Berry (Folio 18r(DB-f18r-d1l.jpg”) using the reverse lexicographic rules to those applied for encoding directory path name qualified filenames, the original file name (200) (e.g., DB-f18r-d1l.jpg), and the original directory path (202) (e.g., C:/Le-Duc-de-Berry/Folio 18r/) of that file on the sender's system, are determined. As shown in this figure, by invoking an automatic saving option (307), the decoded directory path (306) (e.g., C:/Le-Duc-de-Berry/Folio 18r/) is automatically created or accessed (if already existing) in the recipient's computer (304) file system. Then, the file having the detached file name (305) (e.g., DB-f18r-d1l.jpg) is automatically saved on a corresponding folder.

As illustrated by the saving button (307), all the previous operations may be performed in a single user command.

Those skilled in the art will recognize that the present method of attaching or detaching can be processed similarly with a copy of the file.

Method for Encoding the Download Directory Path

According to the invention, the filename of a file that is attached to a document or is accessed through a network is used to encode the directory path of the folder were said file is to be stored on the recipient's computer file system when it is detached from said document or when alternatively it is downloaded from a network. To encode a directory path on a file name, a lexicography grammar is predefined to avoid to encode on the file name those characters that may be forbidden by the file system, e.g., the “\” in the Microsoft Windows system (Windows is a Trademark of Microsoft Corporation).

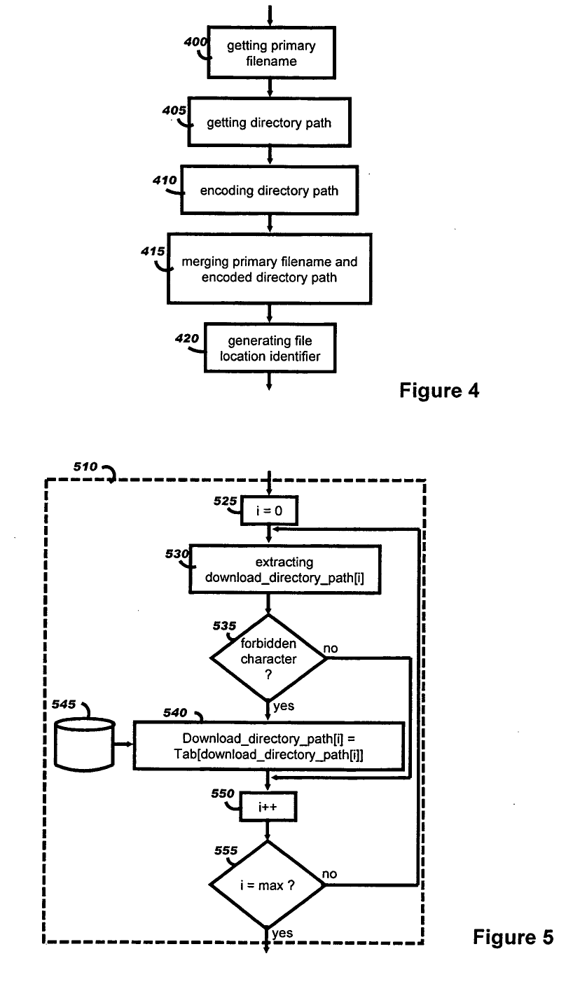

FIG. 4 is a flow chart to illustrate the main steps to encode the download directory path of a folder where a file to be attached is saved.

On a first step (400), the original filename of the file to be attached is picked up. Next step (405) allows to get the directory path (i.e. the folder address) of the file. This full path address will be the address where to download and store the file on the recipient's computer file system. Then, the directory path is encoded (step 410) using the lexicography grammar, and merged with the original filename of the attached file (step 415).

On next step (420) the new file is renamed to get a file location identifier.

FIG. 5 depicts an embodiment of the encoding step 410 of FIG. 4. A variable “i” is first set to zero (step 525). The “i^{th}” character is extracted from the download directory path (step 530). On next step (535) a test is performed to determine whether the “i^{th}” extracted character is valid or forbidden by the syntax rules of the recipient's computer system. If the extracted character is valid, then variable “i” is incremented to the next one (step 550) and a test is performed to determine if the variable has reached its maximum value (step 555).

If the variable has not reached its maximum value, the process goes back to step 530 and iterates until the maximum value is reached.

If the variable has reached its maximum value, meaning that all characters of the directory path have been tested, then the process ends.

As already mentioned, if a character extracted from the download directory path is forbidden by syntax rules, then a corresponding valid character, or group of characters, is selected from a lexicography table (step 545) to replace the forbidden one.

Going back to FIG. 2 to illustrate the previous explained algorithm, an e-mail (201) wherein the filename (200) of the attached file (203) has been modified to embed the directory path where to download the file on the recipient's system.

One may consider the case of an image saved in a “JPEG” format and named “DB-f18r-d1l.jpg” (200) that a user would like to send to a recipient as an e-mail attachment. The lexicography grammar used to encode the download directory path contains at least the following correspondence of characters:

“:” is associated to “..” and “/” is associated to “(”.

For the sake of illustration, this file is to be detached and downloaded by the recipient to following directory path:

C:/Le-Duc-de-Berry

18r/

When the sender attaches the file “DB-f18r-d1l.jpg” to the electronic document, a copy option such as “Copy full path” (205) can be directly selected to allow the automatic and complete copying and encoding of the directory path.

The filename is thus modified according to the process described with reference to FIG. 4. Primary, using the lexicography grammar, the directory path is encoded as follows:

C..(Le-Duc-de-Berry(Folio 18r)

Then, the encoded directory path is merged with the filename and the attached file is renamed using this modified filename.

In this example, the encoded directory path is appended to the primary filename as follows:

C..(Le-Duc-de-Berry(Folio 18r(DB-f18r-d1l.jpg

Once attached, the file may be sent to the recipient in a common way.

When received by the recipient, the attached file of the above mentioned e-mail may be processed as a detached file. By selecting the file location identifier, a test is performed to determine whether or not there is a directory path encoded on the file location identifier so as to determine whether or not a download directory path must be extracted and decoded from it.

Next, using the same lexicographic grammar as in the sender system, the file location identifier is parsed to decode the download directory path. To that end, symbols or groups of symbols of the encoded directory path that are not compatible with the file system rules of the recipient's system are replaced by symbols or group of symbols that are compatible with, using a lexicography grammar.

The grammar describes the correspondence of symbols and may be store in a memory area of the recipient's system as a replacement table.

Once the download directory path is decoded, the file may be saved at the corresponding saving location with its file name.

Those skilled in the art will appreciate that modifications and variations may be made to the above without departing from the scope of the invention.

1. A method of attaching at least one file saved on a sender file system to an electronic document, the method comprising the steps of:
(a) selecting a filename of the at least one file to be attached;
(b) encoding the corresponding file directory path name where the at least one file is saved on the sender file system;
(c) merging the encoded file directory path name with the selected filename to form a file location identifier thereby indicating a location where to save the file on a receiver file system; and
(d) generating into the electronic document an attached file from the file location identifier.

2. The method of claim 1, wherein the step of encoding comprises replacing one or more symbols of the file directory path name using predefined replacement lexicography rules.

3. The method of claim 2, wherein the predefined lexicography rules are stored in a memory area of the sender file system.

4. The method of claim 2, wherein the predefined lexicography rules are stored as a table in a memory area of the receiver file system.

5. The method claim 2, wherein the encoding step, the merging step and the generating step are performed in a single user command.

6. The method of claim 2, wherein the step of encoding comprises:
determining a non valid symbol of the file directory path name;
replacing said symbol using the replacement lexicography rules; and
repeating said previous steps of determining and replacing.

7. The method of claim 1, wherein the encoding step, the merging step and the generating step are performed in a single user command.

8. The method of claim 1 wherein the step of encoding comprises:
determining a non valid symbol of the file directory path name;
replacing said symbol using the replacement lexicography rules; and
repeating said previous steps of determining and replacing.

9. A computer program product stored on a medium readable by a computer machine, the computer program product, comprising:
(a) program means for selecting a filename of the at least one file to be attached;
(b) program means for encoding a corresponding file directory path name where the at least one file is saved on a sender file system;
(c) program means for merging the encoded file directory path name with the selected filename to form a file location identifier thereby indicating a location where to save the file on a receiver file system; and
(d) program means for generating into the electronic document an attached file from the file location identifier.

10. The computer program product of claim 9, wherein the program means for encoding step, the program means for merging step and the program means for generating step comprise a single user command.

11. A method of detaching at least one file from an electronic document on a receiver file system, the at least one file being referenced by a file being assigned a file directory path name that is encoded on a sender file system, and the encoded file directory path name is merged with the filename to form a file location identifier, the method comprising the steps of:
(a) extracting from the electronic document the file location identifier of the at least one file to be detached;
(b) parsing the extracted file location identifier to decode the file directory path name and the filename associated to said file location identifier;
(c) generating a saving location associated to the file directory path name; and
(d) saving the at least one file at the associated saving location.

12. The method of claim 11, wherein the step of parsing comprises replacing one or more symbols of the file location identifier using predefined parsing lexicography rules.

13. The method of claim 12, wherein the predefined parsing lexicography rules are stored as a table in a memory area of the receiver file system.

14. The method of any one of claim 12, wherein the parsing step, the generating step and the saving step are performed in a single user command.

15. The method of claim 11, wherein the parsing step, the generating step and the saving step are performed in a single user command.

16. The method of claim 11, wherein the step of parsing comprises:
determining a non valid symbol in the file location identifier;
replacing said symbol using the replacement parsing lexicography rules; and
repeating said previous steps of determining and replacing.
